(19) United States
(12) Patent Application Publication
(10) Pub. No.: US 2012/0072888 A1
(43) Pub. Date: Mar. 22, 2012

(54) INFORMATION PROCESSING APPARATUS, LOGGING METHOD, AND NON-TRANSITORY COMPUTER-READABLE RECORDING MEDIUM ENCODED WITH LOGGING PROGRAM

(75) Inventor: Tetsuya SUGIMOTO, Muko-shi (JP)

(73) Assignee: Konica Minolta Business Technologies, Inc., Chiyoda-ku (JP)

(21) Appl. No.: 13/231,536

(22) Filed: Sep. 13, 2011

(30) Foreign Application Priority Data
Sep. 17, 2010 (JP) 2010-209185

(51) Int. Cl. G06F 9/44

(52) U.S. Cl. 717/128

(57) ABSTRACT

An information processing apparatus includes an application executing portion which executes an application program, a setting portion which sets whether to keep a log of the application program executed by the application executing portion, and a logging portion which, in the case where it has been set to keep the log by the setting portion, keeps a log of the application program executed, wherein the logging portion includes a determination portion which determines whether the execution of the application program is assured externally, and a forced logging portion which keeps a log of the application program executed, in the case where it is determined that the execution of the application program is not assured externally, even if it has been set not to keep the log by the setting portion.

This application is based on Japanese Patent Application No. 2010-209185 filed with Japan Patent Office on Sep. 17, 2010, the entire content of which is hereby incorporated by reference.

### BACKGROUND OF THE INVENTION

1. Field of the Invention

The present invention relates to an information processing apparatus, a logging method, and a non-transitory computer-readable recording medium encoded with a logging program. More particularly, the present invention relates to an information processing apparatus which keeps a log when it executes an application program installed therein, and a logging method and a non-transitory computer-readable recording medium encoded with a logging program which are executed by the information processing apparatus.

2. Description of the Related Art

A system is known in which, to make an application program available to users, the program is stored in a server which manages the application program, and a user is allowed to download the program therefrom (Japanese Patent Laid-Open No. 2002-312506). The downloaded application program, however, may not necessarily operate correctly, depending on a condition of an apparatus. Therefore, there is known a multi-function peripheral (hereinafter, referred to as an “MFP”) provided with a function of keeping a log every time the MFP executes an application program.

Such an MFP having the logging function keeps logs of all application programs installed therein. When a central processing unit (CPU) that executes the application programs keeps the logs, however, the load on the CPU will increase. While it will be necessary to keep logs for some application programs, it is unnecessary to do so for other application programs. For example, the necessity to keep a log is low for an application program which has a low probability that the execution thereof will cause an error. It however takes lots of troublesome work to set whether to keep a log or not for each of a plurality of application programs.

### SUMMARY OF THE INVENTION

According to an aspect of the present invention, an information processing apparatus includes: an application executing portion configured to execute an application program; a setting portion configured to set whether to keep a log of the application program executed by the application executing portion; and a logging portion configured to, in the case where it has been set to keep the log by the setting portion, keep a log of the application program executed, wherein the logging portion includes a determination portion configured to determine whether the execution of the application program is assured externally, and a forced logging portion configured to keep a log of the application program executed, in the case where it is determined that the execution of the application program is not assured externally, even if it has been set not to keep the log by the setting portion.

According to another aspect of the present invention, an information processing apparatus includes: an application executing portion configured to execute an application program; an assurance level detecting portion configured to detect a qualified assurance level at which the application program is assured externally, and detect which one of a plurality of predetermined assurance levels the qualified assurance level corresponds to; a logging level determining portion configured to, in the case where the qualified assurance level has been detected by the assurance level detecting portion, determine a logging level corresponding to the detected assurance level by referring to a log level table in which the plurality of assurance levels are associated with a plurality of logging levels, respectively, such that the higher the assurance level, the lower the logging level; a logging portion configured to keep a log of the application program executed, with information content that is specified by the determined logging level; and a forced logging portion configured to, in the case where no qualified assurance level has been detected by the assurance level detecting portion, keep a log of the application program executed, with information content that is specified by a highest logging level among the plurality of logging levels at which a largest amount of information content is kept in the log.

According to a further aspect of the present invention, an information processing apparatus includes: an application executing portion configured to execute an application program; a determination portion configured to determine whether the execution of the application program is assured externally; and a logging portion configured to, in the case where it is determined that the execution of the application program is assured externally, keep no log of the application program executed, and configured to, in the case where it is determined that the execution of the application program is not assured externally, keep a log of the application program executed.

According to a still further aspect of the present invention, a logging method includes: a step of executing an application program; a step of setting whether to keep a log of the application program executed; and a logging step of, in the case where it has been set to keep the log, keeping a log of the application program executed, wherein the logging step includes a step of determining whether the execution of the application program is assured externally, and a step of keeping a log of the application program executed, in the case where it is determined that the execution of the application program is not assured externally, even if it has been set not to keep the log in the setting step.

According to yet another aspect of the present invention, a logging method includes: a step of executing an application program; a step of detecting a qualified assurance level at which the application program is assured externally, and detecting which one of a plurality of predetermined assurance levels the qualified assurance level corresponds to; a step of, in the case where the qualified assurance level has been detected in the detecting step, determining a logging level corresponding to the detected assurance level by referring to a log level table in which the plurality of assurance levels are associated with a plurality of logging levels, respectively, such that the higher the assurance level, the lower the logging level; a step of keeping a log of the application program executed, with information content that is specified by the determined logging level; and a step of, in the case where no qualified assurance level has been detected in the detecting step, keeping a log of the application program executed, with information content that is specified by a highest logging level among the plurality of logging levels at which a largest amount of information content is kept in the log.

According to yet another aspect of the present invention, a logging method includes: a step of executing an application program; a step of determining whether the execution of the application program is assured externally; and a step of, in the case where it is determined that the execution of the application program is assured externally, keeping no log of the application program executed, and, in the case where it is determined that the execution of the application program is not assured externally, keeping a log of the application program executed.

According to yet another aspect of the present invention, a non-transitory computer-readable recording medium is encoded with a logging program, the logging program causing a computer to execute: a step of executing an application program; a step of setting whether to keep a log of the application program executed; and a logging step of, in the case where it has been set to keep the log, keeping a log of the application program executed, wherein the logging step includes a step of determining whether the execution of the application program is assured externally, and a step of keeping a log of the application program executed, in the case where it is determined that the execution of the application program is not assured externally, even if it has been set not to keep the log in the setting step.

According to yet another aspect of the present invention, a non-transitory computer-readable recording medium is encoded with a logging program, the logging program causing a computer to execute: a step of executing an application program; a step of detecting a qualified assurance level at which the application program is assured externally, and detecting which one of a plurality of predetermined assurance levels the qualified assurance level corresponds to; a step of, in the case where the qualified assurance level has been detected in the detecting step, determining a logging level corresponding to the detected assurance level by referring to a log level table in which the plurality of assurance levels are associated with a plurality of logging levels, respectively, such that the higher the assurance level, the lower the logging level; a step of keeping a log of the application program executed, with information content that is specified by the determined logging level; and a step of, in the case where no qualified assurance level has been detected in the detecting step, keeping a log of the application program executed, with information content that is specified by a highest logging level among the plurality of logging levels at which a largest amount of information content is kept in the log.

According to yet another aspect of the present invention, a non-transitory computer-readable recording medium is encoded with a logging program, the logging program causing a computer to execute: a step of executing an application program; a step of determining whether the execution of the application program is assured externally; and a step of, in the case where it is determined that the execution of the application program is assured externally, keeping no log of the application program executed, and, in the case where it is determined that the execution of the application program is not assured externally, keeping a log of the application program executed.

The foregoing and other features, aspects, and advantages of the present invention will become more apparent from the following detailed description of the present invention when taken in conjunction with the accompanying drawings.

### BRIEF DESCRIPTION OF THE DRAWINGS

FIG. 1 schematically shows an application sharing system according to an embodiment of the present invention;

FIG. 2 is a perspective view of an MFP;

FIG. 3 is a block diagram showing an example of the hardware configuration of the MFP;

FIG. 4 is a block diagram schematically showing the functions of a CPU included in the MFP according to a first embodiment of the present invention, together with data stored in a HDD;

FIG. 5 is a flowchart illustrating an example of the flow of an installation process according to the first embodiment;

FIG. 6 is a flowchart illustrating an example of the flow of a logging process according to the first embodiment;

FIG. 7 is a block diagram schematically showing the functions of a CPU included in the MFP according to a second embodiment of the present invention, together with data stored in a HDD;

FIG. 8 shows an example of log level information;

FIGS. 9A to 9C show examples of a log;

FIG. 10 is a flowchart illustrating an example of the flow of the installation process according to the second embodiment;

FIG. 11 is a flowchart illustrating an example of the flow of the logging process according to the second embodiment;

FIG. 12 is a block diagram schematically showing the functions of a CPU included in the MFP according to a third embodiment of the present invention, together with data stored in a HDD; and

FIG. 13 is a flowchart illustrating an example of the flow of the logging process according to the third embodiment.

### DESCRIPTION OF THE PREFERRED EMBODIMENTS

The preferred embodiments of the present invention will be described below in conjunction with the drawings. In the following description, the same or corresponding parts are denoted by the same reference characters. Their names and functions are also the same. Thus, a detailed description thereof will not be repeated.

### First Embodiment

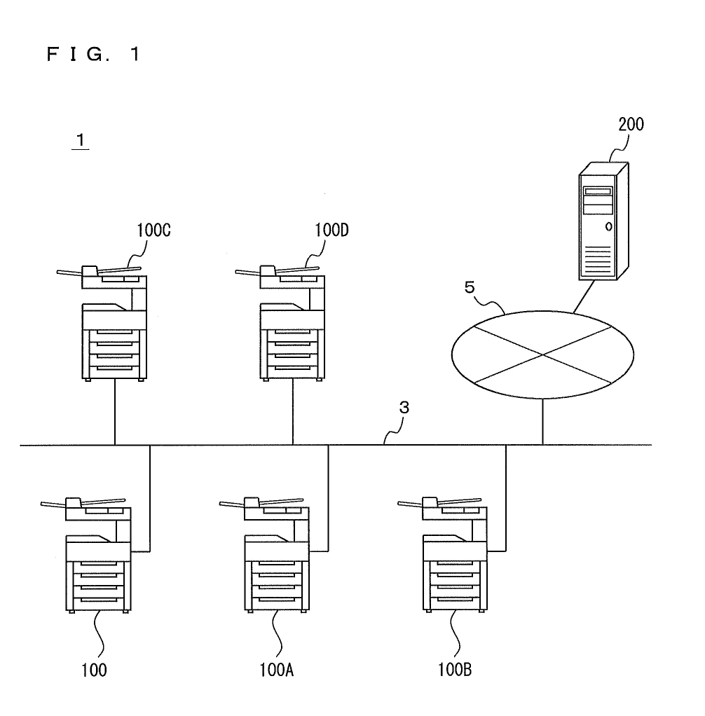

FIG. 1 schematically shows an application sharing system according to an embodiment of the present invention. Referring to FIG. 1, an application sharing system 1 includes multi-function peripherals (MFPs) 100 and 100A to 100D, which are each connected to a network 3, and a search server 200 which is connected to the Internet 5.

MFPs 100 and 100A to 100D, which are examples of an information processing apparatus, each have a plurality of functions such as the scanner function, function as a printer, copying function, and facsimile transmitting/receiving function. MFPs 100 and 100A to 100D each have a common gateway interface (CGI) and serve as an Internet web server (hereinafter, referred to as the “IWS”). Further, an application program interface (API) as a function for starting a CGI has been released, allowing a user to use the API to develop an application program and install the same in any of MFPs 100 and 100A to 100D. Furthermore, MFPs 100 and 100A to 100D each have a browsing program installed therein, and a task that executes the browsing program serves as a user interface of any of MFPs 100 and 100A to 100D that serves as the IWS.

Network 3 is a local area network (LAN), which may be connected in a wired or wireless manner. MFPs 100 and 100A to 100D are capable of communicating with each other via network 3, and with search server 200 connected via the Internet 5. Network 3 is not necessarily the LAN; it may be the Internet, a wide area network (WAN), public switched telephone networks (PSTN), and the like.

Search server 200 is a typical computer. In the present embodiment, it is assumed that search server 200 is a computer which is managed by the manufacturer of MFPs 100 and 100A to 100D. An application program which has been installed in any of MFPs 100 and 100A to 100D is uploaded to search server 200. The uploaded application program is stored therein in a searchable state, and later downloaded as appropriate. In search server 200, besides the application program(s) installed in MFPs 100 and 100A to 100D, an application program which has been developed by and supplied from the manufacturer may be stored in a searchable state. While it is assumed in the present embodiment that search server 200 is a computer which is managed by the manufacturer of MFPs 100 and 100A to 100D, search server 200 may be a computer which is managed by a person or a party having no relation with the manufacturer.

An application program stored in search server 200 may be stored in association with authentication information. The authentication information is information which assures the execution of the application program. Authentication information may be given to and associated with an application program by an administrator of search server 200, or may be given to and associated with an application program by a developer of the application program. Still alternatively, a third-party authenticator may assign authentication information to an application program stored in search server 200 so that the authentication information is associated with the application program.

MFPs 100 and 100A to 100D may all have the same functions, or may each have different functions. Basically, MFPs 100 and 100A to 100D each have at least an image forming function for forming an image on a sheet of paper or the like, and may additionally include any of the following functions: an image reading function of reading a document to output image data; an image processing function of processing the image data; a post-processing function of performing punching, sorting, or other post-processing on the sheets of paper on which images have been formed; and a facsimile transmitting/receiving function.

While MFPs 100 and 100A to 100D may have different functions, it is here assumed that MFP 100 has any function included in any of the other MFPs 100A to 100D.

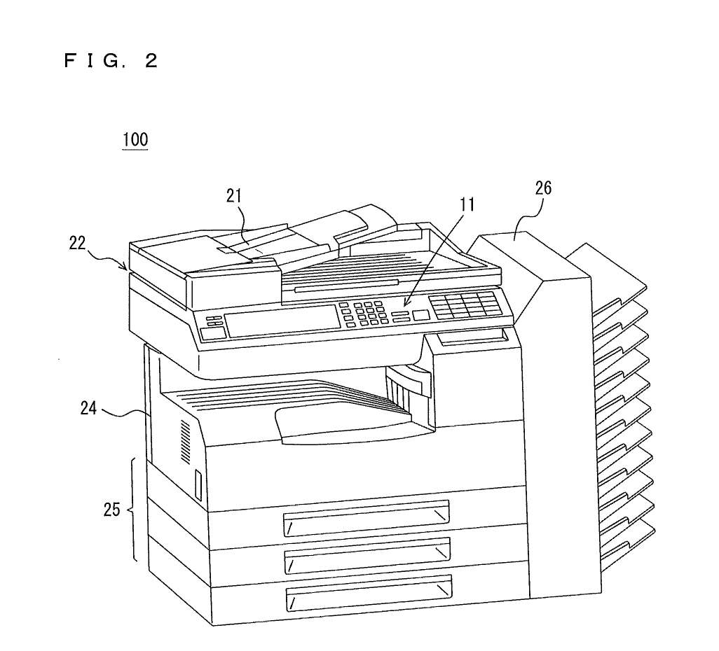

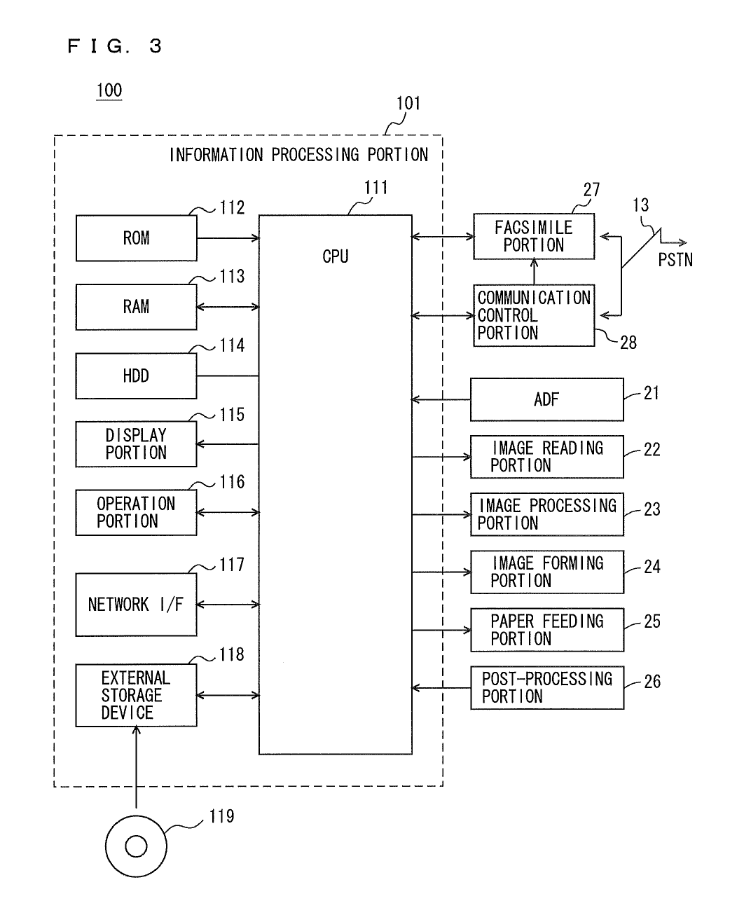

FIG. 2 is a perspective view of the MFP. Referring to FIG. 2, MFP 100 includes an automatic document feeder (ADF) 21, an image reading portion 22, an image processing portion 23 (see FIG. 3), an image forming portion 24, a paper feeding portion 25, and a post-processing portion 26. MFP 100 also has, on its upper surface, an operation panel 11 serving as a user interface.

FIG. 3 is a block diagram showing an example of the hardware configuration of the MFP. Referring to FIG. 3, MFP 100 includes: an information processing portion 101; a facsimile portion 27; a communication control portion 28; ADF 21; image reading portion 22; image processing portion 23; image forming portion 24; paper feeding portion 25; and post-processing portion 26. Information processing portion 101 includes: a central processing unit (CPU) 111; a read only memory (ROM) 112 which stores a program executed by CPU 111 and others; a random access memory (RAM) 113 used as a work area for CPU 111; a hard disk drive (HDD) 114 which stores data in a nonvolatility manner; a display portion 115; an operation portion 116; a network interface (I/F) 117; and an external storage device 118. CPU 111 is connected with ROM 112, RAM 113, HDD 114, display portion 115, operation portion 116, network I/F 117, and external storage device 118, and is responsible for overall control of information processing portion 101. Further, CPU 111 is connected with facsimile portion 27, communication control portion 28, ADF 21, image reading portion 22, image processing portion 23, image forming portion 24, paper feeding portion 25, and post-processing portion 26, and is responsible for overall control of MFP 100.

ADF 21 carries a plurality of documents set in a document feed tray one by one to image reading portion 22. To cause image reading portion 22 to read only one side of a document, ADF 21 carries a document to image reading portion 22 to cause it to read the side. To cause image reading portion 22 to read both sides of a document, ADF 21 carries a document to image reading portion 22 to cause it to read one side, before turning the document over and carrying the same to image reading portion 22 to cause it to read the other side. Image reading portion 22 optically reads image information such as a photograph, character, picture, and the like from a document to obtain image data, and outputs the image data to image processing portion 23.

Image processing portion 23 is controlled by CPU 111, and performs image processing on image data on the basis of an instruction from CPU 111. The image data includes: image data output from image reading portion 22 which has read a document; image data included in a print job which is received from another computer by network I/F 117; image data which is received from any of the other MFPs 100A to 100D by network I/F 117; and image data which is stored in HDD 114. The image processing includes, for example: zoom-in processing for zooming in on an image; zoom-out processing for zooming out on an image; synthesis processing for synthesizing a plurality of images to generate an image; and rotation processing for rotating an image to change the direction of the image. Image processing portion 23 outputs the processed image data to image forming portion 24.

Paper feeding portion 25 has a plurality of paper feed trays, and supplies sheets of paper stored in a designated paper feed tray, one by one, to image forming portion 24. The paper feed trays each store sheets of paper of a size selected from a plurality of sizes, in the state where the sheets are placed in an orientation selected from a plurality of orientations. It is here assumed that paper feeding portion 25 has four paper feed trays of paper feed tray 1 to paper feed tray 4, wherein paper feed tray 1 stores A4-size sheets in portrait orientation, paper feed tray 2 stores A4-size sheets in landscape orientation, paper feed tray 3 stores A3-size sheets in portrait orientation, and paper feed tray 4 stores B5-size sheets in landscape orientation. When both-side printing is designated, paper feeding portion 25 feeds a sheet of paper to image forming portion 24 once, and again with the sheet turned over, so that images are formed on both sides of the sheet.

Image forming portion 24 forms an image on the sheet of paper fed from paper feeding portion 25, on the basis of the image data received from image processing portion 23.

Post-processing portion 26 discharges sheets of paper having images formed thereon. Post-processing portion 26 has a plurality of paper discharge trays, and includes a sorting portion, a hole-punching portion, and a stapling portion. The sorting portion sorts and discharges a plurality of sheets of paper, on which images have been formed, to a plurality of paper discharge trays. The hole-punching portion punches the sheets. The stapling portion staples as a set a plurality of sheets of paper on which images have been formed.

Display portion 115 is a display such as a liquid crystal display (LCD), an organic electro-luminescence display (ELD) or the like, and displays an instruction menu for a user, information about acquired image data, and others. Operation portion 116, which is provided with a plurality of keys, accepts data input such as instructions, characters, and numerical characters, according to the key operations by the user. Operation portion 116 further includes a touch panel provided on display portion 115. Display portion 115 and operation portion 116 constitute operation panel 11.

Network I/F 117 is an interface for communication according to a communication protocol such as transmission control protocol (TCP) or user datagram protocol (UDP). Network I/F 117 communicates with search server 200 via network 3 and the Internet 5, and also communicates with other MFPs 100A to 100 D which are connected to network 3.

External storage device 118 is mounted with a compact disc read-only memory (CD-ROM) 119. CPU 111 is capable of accessing CD-ROM 119 via external storage device 118, and loading a program, which is stored in CD-ROM 119, into RAM 113 for execution. It is noted that the program executed by CPU 111 is not restricted to the program stored in CD-ROM 119. It may be a program stored in another storage medium, or in HDD 114. Still alternatively, it may be a program written into HDD 114 by another computer connected to network 3 via network I/F 117.

It is noted that the storage medium for storing a program is not restricted to CD-ROM 119. It may be an optical disc (magneto-optical (MO) disc, mini disc (MD), digital versatile disc (DVD)), an IC card, an optical card, or a semiconductor memory such as a mask ROM, an erasable programmable ROM (EPROM), an electrically erasable and programmable ROM (EEPROM), or the like.

Facsimile portion 27 is connected to public switched telephone networks (PSTN) 13, and transmits facsimile data to or receives facsimile data from PSTN 13. Facsimile portion 27 converts the received facsimile data to print data which can be printed by image forming portion 24, and outputs the print data to image forming portion 24. Image forming portion 24 in turn prints the facsimile data received by facsimile portion 27 on a sheet of paper. Further, facsimile portion 27 converts the data stored in HDD 114 to facsimile data, and transmits the facsimile data to a facsimile machine connected to PSTN 13.

HDD 114 stores environmental information of MFP 100. The environmental information includes: connection information which shows a connection status of a peripheral device connected to MFP 100; and setting information which includes a set value of a prescribed setting item for each of the functions included in MFP 100. The connection status shows the presence or absence of connection of each of ADF 21, image reading portion 22, image processing portion 23, and post-processing portion 26. The functions included in MFP 100 includes a both-side reading function, a color printing function, a paper feeding function, a both-side printing function, an image processing function, a post-processing function, and a communication function. The setting item and the set value for the both-side reading function show whether it is possible to read both sides of a document. The setting item and the set value for the color printing function show whether it is possible to print in color. The setting item and the set value for the paper feeding function show whether it is possible to select sheets of A4 portrait, A4 landscape, A3 portrait, and B5 landscape. The setting item and the set value for the both-side printing function show whether it is possible to form an image on one side or both sides of a sheet of paper. The setting item and the set value for the image processing function show whether it is possible to perform scaling processing for changing an image in size and N-in-1 processing for combining images on a plurality of pages to form an image on a sheet. The setting item and the set value for the post-processing function show whether it is possible to perform sorting processing, stapling processing, and hole-punching processing. The setting item and the set value for the communication function show the version information of simple network management protocol (SNMP).

MFPs 100 and 100A to 100D each have at least image forming portion 24 and paper feeding portion 25, and may additionally include one or more of ADF 21, image reading portion 22, image processing portion 23, post-processing portion 26, and facsimile portion 27. That is, there may be one, among MFPs 100 and 100A to 100D, which has not all the elements of ADF 21, image reading portion 22, image processing portion 23, image forming portion 24, paper feeding portion 25, post-processing portion 26, and facsimile portion 27. The functions included in MFPs 100 and 100A to 100D may vary from each other in accordance with which one(s) of ADF 21, image reading portion 22, image processing portion 23, image forming portion 24, paper feeding portion 25, post-processing portion 26, and facsimile portion 27 the respective MFPs include therein.

Further, while it is here assumed that image processing portion 23 performs the zoom-in processing, zoom-out processing, synthesis processing, and rotation processing as described above, image processing portion 23 only needs to be able to perform at least one of the zoom-in processing, zoom-out processing, synthesis processing, and rotation processing. Therefore, among ones of MFPs 100 and 100A to 100D provided with image processing portions 23, the functions included in those MFPs may vary from each other in accordance with which one(s) of the zoom-in processing, zoom-out processing, synthesis processing, and rotation processing the respective image processing portions 23 are able to perform.

Furthermore, while it is here assumed that post-processing portion 26 has the sorting function, stapling function, and hole-punching function as described above, post-processing portion 26 only needs to have at least one of these functions. That is, there may be post-processing portion 26, included in one of MFPs 100 and 100A to 100D, which has not all the functions of sorting, stapling, and hole-punching. Therefore, among ones of MFPs 100 and 100A to 100D provided with post-processing portions 26, the functions included in those MFPs may vary from each other in accordance with which one(s) of the sorting function, stapling function, and hole-punching function the respective post-processing portions 26 include.

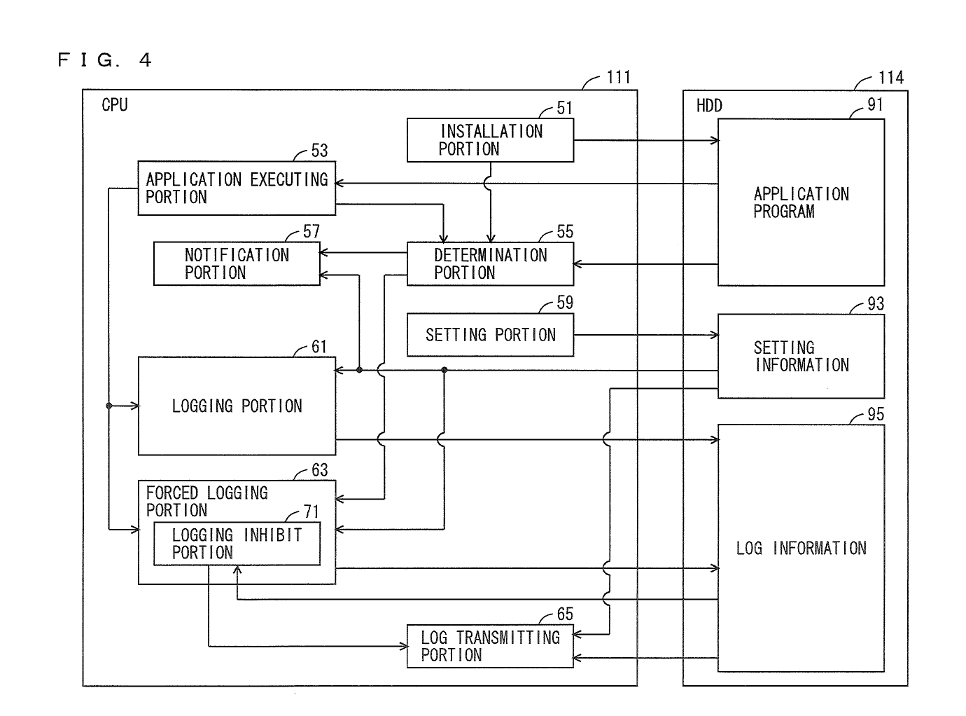

FIG. 4 is a block diagram schematically showing the functions of a CPU included in the MFP according to the first embodiment, together with data stored in a HDD. The functions shown in FIG. 4 are implemented in CPU 111 included in MFP 100 as CPU 111 executes a logging program stored in ROM 112, HDD 114, or CD-ROM 119.

Referring to FIG. 4, CPU 111 includes: an installation portion 51 which installs an application program; an application executing portion 53 which executes the installed application program; a determination portion 55 which determines whether the installed application program is assured externally; a notification portion 57 which notifies a user; a setting portion 59 which enables a logging function; a logging portion 61 which keeps a log of an application program; a forced logging portion 63; and a log transmitting portion 65.

Installation portion 51 installs an application program which is acquired from the outside. Specifically, installation portion 51 downloads an application program from search server 200 to acquire and store the application program in HDD 114. As a result, an application program 91 is stored in HDD 114. In the case where the application program downloaded from search server 200 is associated with authentication information, application program 91 and the authentication information are stored together in HDD 114.

Installation portion 51 installs an application program by performing various processes for setting application program 91 stored in HDD 114 to be executable. The processes performed by installation portion 51 for installing application program 91 may include a process of adding, on a menu screen, a button for instructing the execution of the application program. It is noted that application program 91 is not restricted to the one downloaded from search server 200. It may be an application program which has been created by a user by inputting API functions into operation portion 116, or an application program described in API functions, which has been created by a user using a personal computer. Installation portion 51 outputs application identification information for identifying the installed application program 91, to determination portion 55.

Setting portion 59 enables a logging function. When a user inputs to operation portion 116 an operation of enabling the logging function, setting portion 59 stores in HDD 114 setting information showing that the logging function is enabled. When a user inputs to operation portion 116 an operation of disabling the logging function, setting portion 59 stores in HDD 114 setting information showing that the logging function is disabled. As a result, setting information 93 showing that the logging function is enabled or disabled is stored in HDD 114.

Application executing portion 53 executes application program 91 stored in HDD 114. Application executing portion 53 executes application program 91 on the basis of an operation input to operation portion 116 by a user. In the case where a plurality of application programs 91 are stored in HDD 114, application executing portion 53 executes one or more of those application programs 91 that the user has selected by operating operation portion 116. For example, application executing portion 53 displays a list of application programs on display portion 115, and when a user selects at least one application program from the list, application executing portion 53 selects the at least one application program to be executed, from among the plurality of application programs stored in HDD 114. Once application executing portion 53 has executed an application program, application executing portion 53 outputs application identification information for identifying the executed application program, to determination portion 55, logging portion 61, and forced logging portion 63. Application executing portion 53 also outputs the result of executing the application program to logging portion 61 and forced logging portion 63. The result of executing the application program includes either “normal termination” or “abnormal termination”. The execution result may indicate either “normal termination” or “abnormal termination” for each command included in the application program, or for each process in MFP 100. Further, in the case of “abnormal termination”, the result may include an error code which is predetermined for the error that has led to the abnormal termination.

Determination portion 55 determines whether the execution of the application program is assured externally. In the case where authentication information is associated with application program 91 stored in HDD 114, determination portion 55 determines that the execution of application program 91 is assured. In the case where no authentication information is associated with application program 91, then determination portion 55 determines that the execution thereof is not assured. In the case where determination portion 55 receives application identification information from installation portion 51, determination portion 55 determines whether authentication information is associated with application program 91 specified by the application identification information. When determining that no authentication information is associated with application program 91, determination portion 55 outputs a notification instruction to notification portion 57.

In the case where determination portion 55 receives application identification information from application executing portion 53, determination portion 55 determines whether authentication information is associated with application program 91 specified by the application identification information. When determining that no authentication information is associated with application program 91, determination portion 55 outputs a logging instruction to forced logging portion 63.

When notification portion 57 receives a notification instruction from determination portion 55, notification portion 57 notifies a user that the log is to be forcibly kept and that the logs are to be transmitted to the outside, provided that setting information 93 shows that the logging function is disabled. Specifically, notification portion 57 displays on display portion 115 a message to the effect that the log is to be forcibly kept and a message to the effect that the logs are to be transmitted to the outside. For example, the message to the effect that the log is to be forcibly kept may read: “It has been set to forcibly keep the log.” The message to the effect that the logs are to be transmitted to the outside may read: “It has been set to externally transmit the logs when the number of errors reaches a prescribed value.”

Logging portion 61 keeps a log of an application program in accordance with setting information 93. Logging portion 61 receives application identification information and an execution result from application executing portion 53. When receiving the application identification information and the execution result from application executing portion 53, logging portion 61 stores the log into HDD 114 provided that setting information 93 shows that the logging function is enabled. As a result, log information 95 is stored in HDD 114. Log information 95 includes a set of the application identification information and the execution result.

Forced logging portion 63 receives application identification information and an execution result from application executing portion 53, and receives a logging instruction from determination portion 55. When receiving the logging instruction from determination portion 55, forced logging portion 63 stores the log into HDD 114 provided that setting information 93 shows that the logging function is disabled and provided that a logging operation is not inhibited by a logging inhibit portion 71, which will be described later. Determination portion 55 outputs a logging instruction when no authentication information is associated with the application program which has been executed by application executing portion 53, i.e. when the execution of the application program is not assured externally. In the case where an application program the execution of which is not assured externally is executed, forced logging portion 63 stores the log, even if the logging function is disabled in setting information 93. The log to be kept is the same as the one which is kept by logging portion 61 described above. Forced logging portion 63 stores in HDD 114 a set of the application identification information and the execution result received from application executing portion 53. In the case of keeping a log, forced logging portion 63 outputs the application identification information received from application executing portion 53, to log transmitting portion 65.

Forced logging portion 63 includes logging inhibit portion 71. Logging inhibit portion 71 extracts, from log information 95 stored in HDD 114, any execution result that makes a pair with the application identification information received from application executing portion 53. Then, logging inhibit portion 71 inhibits forced logging portion 63 from keeping a log provided that the number of execution results showing normal termination included in the extracted execution results meets a prescribed condition. Here, the prescribed condition is that the number of execution results showing normal termination is a predetermined value or more. It is noted that the prescribed condition may be that the ratio of the number of execution results showing normal termination to the number of extracted execution results is a prescribed value or more. If the number of execution results showing normal termination is a prescribed value of more, it is highly likely that a later execution of the application program will end normally. Accordingly, it is configured not to keep a log of such an application program. This allows a least possible number of logs to be kept, thereby reducing the load on CPU 111.

In the case where the logs kept by forced logging portion 63 include a prescribed number or more of the logs showing abnormality, log transmitting portion 65 transmits the logs to the outside. Specifically, when receiving application identification information from forced logging portion 63, log transmitting portion 65 extracts, from log information 95 stored in HDD 114, any execution result that makes a pair with the application identification information received from forced logging portion 63. Then, in the case where the number of execution results showing abnormal termination among the extracted execution results is a prescribed value or more, log transmitting portion 65 transmits all the extracted pieces of log information to search server 200 via network I/F 117.

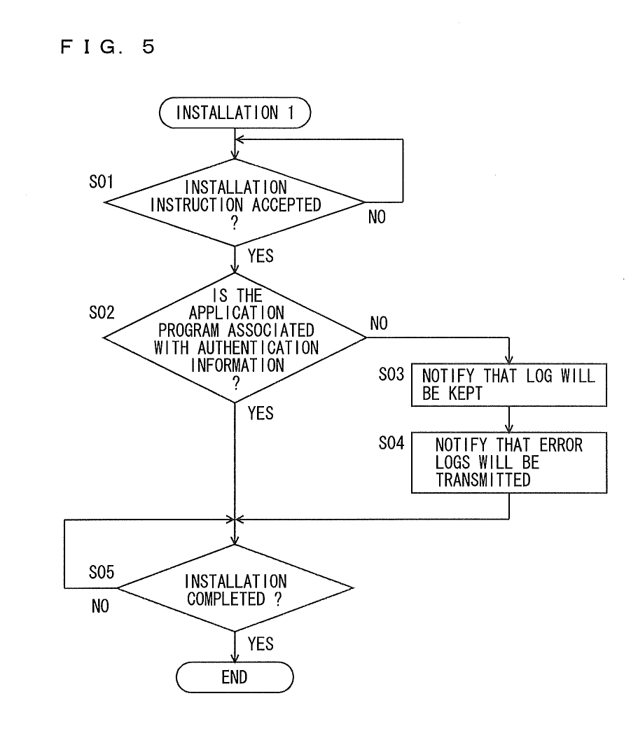

FIG. 5 is a flowchart illustrating an example of the flow of an installation process according to the first embodiment. The installation process is carried out by CPU 111 included in MFP 100 as CPU 111 executes the logging program stored in ROM 112, HDD 114, or CD-ROM 119.

Referring to FIG. 5, CPU 111 determines whether an installation instruction has been accepted (step S01). CPU 111 is in a standby mode until an installation instruction is accepted (NO in step S01), and once the installation instruction is accepted (YES in step S01), the installation is started, and the process proceeds to step S02. The installation instruction includes an instruction for specifying an application program. For example, in the case of downloading an application program from search server 200, the installation instruction includes an instruction to acquire from search server 200 a download screen including a list of the application programs stored in search server 200, and an instruction to download an application program on the download screen.

In step S02, it is determined whether the application program specified by the installation instruction is associated with authentication information. If so, the process proceeds to step S05; otherwise, the process proceeds to step S03. In step S03, CPU 111 displays on display portion 115 a message notifying that the log will be forcibly kept, and the process proceeds to step S04. In step S04, CPU 111 displays on display portion 115 a message notifying that, when the number of error logs being kept reaches a prescribed value, the logs will be transmitted to the search server, and the process proceeds to step S05.

In step S05, CPU 111 determines whether the installation of the application program instructed in step S01 has been completed. CPU 111 is in a standby mode until the installation of the application program is completed (NO in step S05), and once the installation has been completed (YES in step S05), the process is terminated.

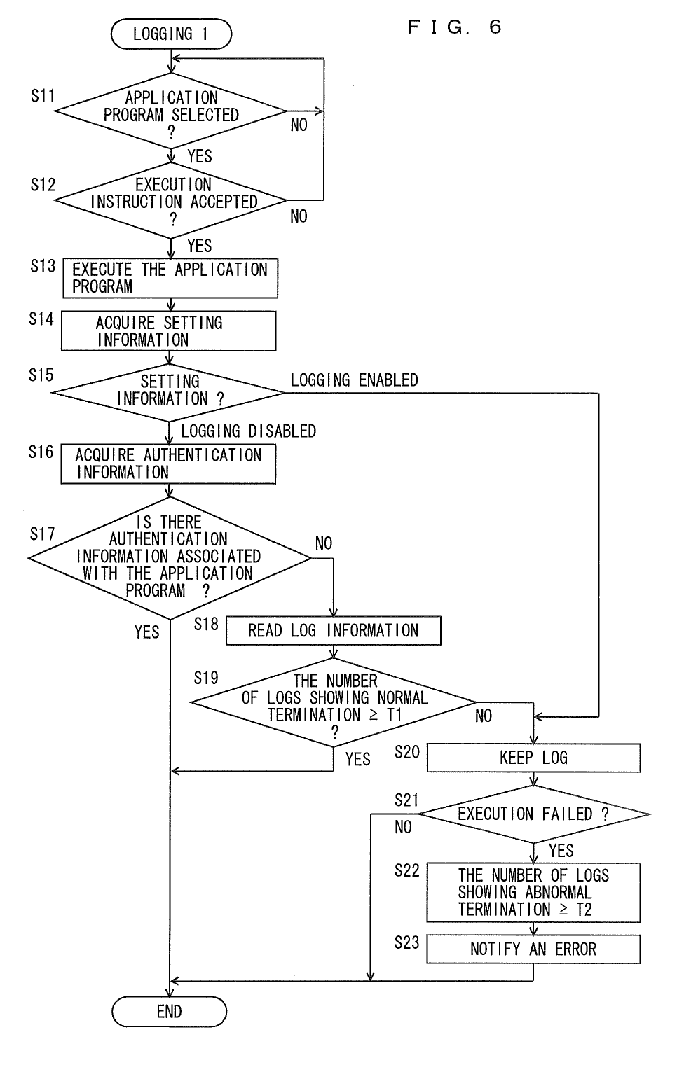

FIG. 6 is a flowchart illustrating an example of the flow of a logging process according to the first embodiment. The logging process is carried out by CPU 111 included in MFP 100 as CPU 111 executes the logging program stored in ROM 112, HDD 114, or CD-ROM 119.

Referring to FIG. 6, CPU 111 determines whether an instruction to select an application program has been accepted (step S11). CPU 111 is in a standby mode until an instruction to select an application program is accepted (NO in step S11), and once the instruction to select an application program is accepted (YES in step S11), the process proceeds to step S12. In other words, the logging process is a process which is performed on the condition that an instruction to select an application program has been accepted.

In step S12, it is determined whether an execution instruction has been accepted. If so, the process proceeds to step S13; otherwise, the process returns to step S11. For example, when a user's operation of pressing a start key included in operation portion 116 is detected, the execution instruction is accepted.

In step S13, the application program selected in step S11 is executed. In the following step S14, setting information is acquired. Here, setting information 93 stored in HDD 114 is acquired. In the following step S15, the process branches in accordance with content of setting information 93. If setting information 93 shows that the logging function is disabled, the process proceeds to step S16. If setting information 93 shows that the logging function is enabled, the process proceeds to step S20.

In step S16, authentication information is acquired. Specifically, the authentication information which is associated with the application program selected in step S11 is acquired. In the following step S17, it is determined whether authentication information is associated with the application program. The process branches in accordance with whether the authentication information has been acquired. If the authentication information is acquired, CPU 111 determines that the execution of the application program is assured externally, and the process is terminated. If no authentication information is acquired, CPU 111 determines that the execution of the application program is not assured externally, and the process proceeds to step S18.

In step S18, log information of the application program selected in step S11 is read. Specifically, CPU 111 reads, from log information 95 stored in HDD 114, any piece of log information 95 that includes the application identification information of the application program selected in step S11.

In the following step S19, it is determined whether the number of logs showing normal termination, among the pieces of log information 95 read in step S18, is a threshold value T1 or more. If so, the process is terminated; otherwise, the process proceeds to step S20. This is because, if the number of logs showing normal termination is the threshold value T1 or more, there is a high probability that a later execution of the application program will end normally.

In step S20, CPU 111 keeps a log of the application program executed in step S13. Specifically, a set of the result of executing the application program and the application identification information of the application program is additionally stored in log information 95 in HDD 114.

In the following step S21, it is determined whether the execution of the application program in step S13 has failed. If so, the process proceeds to step S22; otherwise, the process is terminated. In step S22, it is determined whether the number of logs showing abnormal termination, among log information 95 of the application program executed in step S13, is a threshold value T2 or more. If so, the process proceeds to step S23; otherwise, the process is terminated. In step S23, CPU 111 notifies an error, and the process is terminated. Specifically, CPU 111 transmits the logs of the application program executed in step S13, to search server 200 via network I/F 117.

According to the first embodiment, MFP 100 stores setting information 93 which shows whether a logging function for keeping a log of an application program executed is enabled or disabled. In the case where setting information 93 shows that the logging function is enabled, the log of the application program executed is kept. In the case where no authentication information is associated with an application program, meaning that the execution of the application program is not assured externally, the log of the application program executed is kept even if setting information 93 shows that the logging function is disabled. This makes it possible to keep a log of the application program the execution of which is not assured externally, and not to keep a log of the application program the execution of which is assured externally. An application program the execution of which is not assured externally has a higher probability of occurrence of an error than an application program the execution of which is assured externally. The above configuration is advantageous in that the number of processes of keeping the logs is reduced as compared with the case of keeping the logs of all the application programs. As a result, only the necessary logs are kept, and the load on CPU 111 is reduced as well.

Even in the case of an application program the execution of which is not assured externally, a log of the application program is not kept if a large number of execution results show that the execution thereof has ended normally. This can further reduce the number of processes of keeping the logs.

Furthermore, at the time of installation of an application program, in the case where the execution of the application program being installed is not assured externally and if the logging function is disabled in setting information 93, then a user is notified that the log is to be forcibly kept. This allows the user to be notified that a process having content different from that set by the user will be performed.

Still further, at the time of installation of an application program, in the case where the execution of the application program being installed is not assured externally and where the logging function is disabled in setting information 93, in the event that the logs which have been kept for the application program the execution of which is not assured externally include a prescribed number or more of the logs showing abnormality, then a user is notified that the logs are to be transmitted to search server 200. This allows the user to be notified that a process having content different from that set by the user will be performed.

### Second Embodiment

In application sharing system 1 according to the first embodiment, in the case where the execution of an application program is assured externally, authentication information is associated with the application program. In an application sharing system 1A according to the second embodiment, the authentication information that is associated with an application program has an assurance level which indicates the degree of assurance. It is here assumed that there are three levels of “high”, “middle”, and “low” as the assurance levels. Authentication information may be given to and associated with an application program by an administrator of search server 200, or may be given to and associated with an application program by a developer of the application program. Still alternatively, a third-party authenticator may assign authentication information to an application program stored in search server 200 so that the authentication information is associated with the application program.

It is noted that the authentication information may include, instead of the assurance level itself, authenticator identification information for identifying a person or a party that assures the execution of the application program, and each piece of authenticator identification information may be associated with a certain assurance level in advance. For example, in the case where the authenticator identification information included in the authentication information specifies the manufacturer of MFP 100, it may be associated with the assurance level “high”. Authenticator identification information specifying a predetermined program developer or the like may be associated with the assurance level “middle”. Authenticator identification information specifying others may be associated with the assurance level “low”.

The overall configuration of application sharing system 1A according to the second embodiment is identical to that shown in FIG. 1. The appearance and hardware configuration of MFP 100 are identical to those shown in FIGS. 2 and 3, respectively. Thus, the description thereof will not be repeated here.

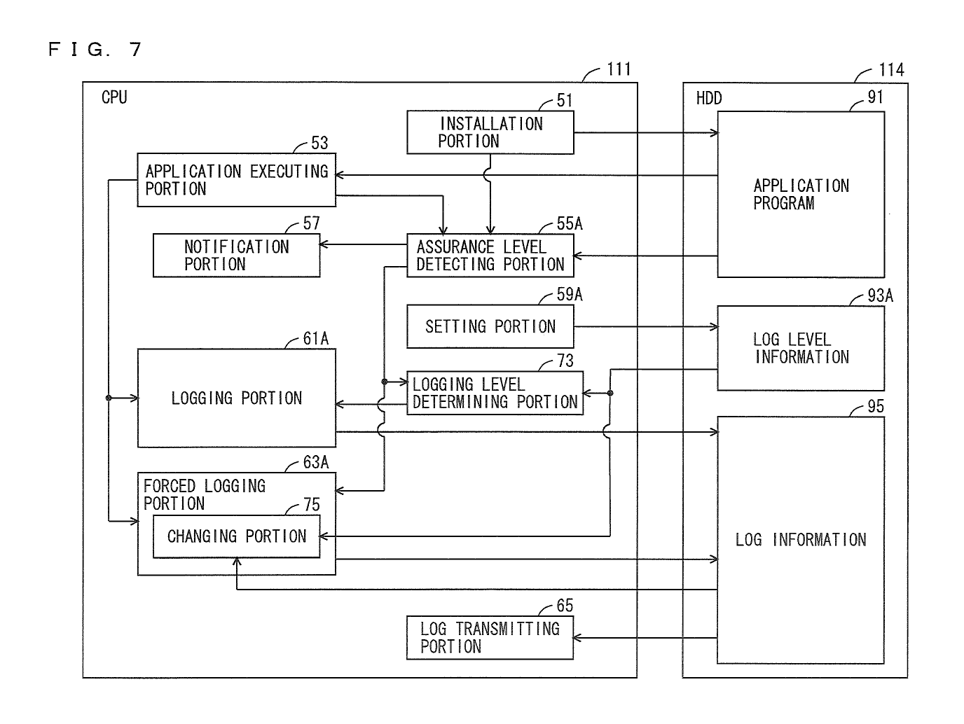

FIG. 7 is a block diagram schematically showing the functions of a CPU included in the MFP according to the second embodiment, together with data stored in a HDD. The functions shown in FIG. 7 are implemented in CPU 111 included in MFP 100 as CPU 111 executes a logging program stored in ROM 112, HDD 114, or CD-ROM 119.

Referring to FIG. 7, it is different from the block diagram shown in FIG. 4 in that determination portion 55, setting portion 59, logging portion 61, and forced logging portion 63 have been changed to an assurance level detecting portion 55A, a setting portion 59A, a logging portion 61A, and a forced logging portion 63A, respectively, and a logging level determining portion 73 has been added. The other functions are similar to those shown in FIG. 4, and thus, the description thereof will not be repeated here.

Setting portion 59A sets an association between an assurance level and a logging level. The logging level specifies information content that is to be kept in a log. Specifically, setting portion 59A accepts an association between an assurance level and a logging level which is input to operation portion 116 by a user, and stores the accepted association into HDD 114 as log level information. As a result, log level information 93A is stored in HDD 114.

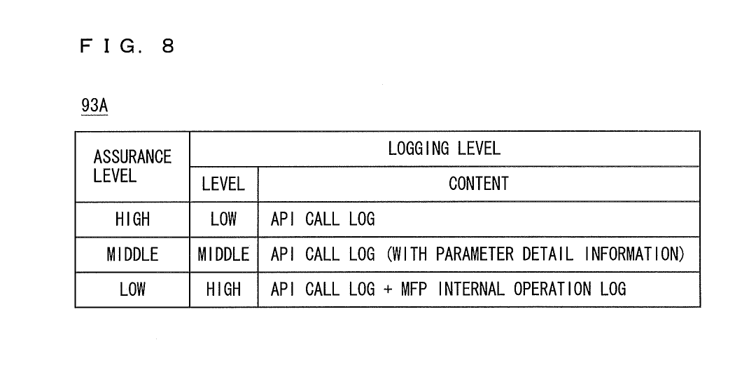

FIG. 8 shows an example of log level information. Referring to FIG. 8, log level information 93A includes an “assurance level” field and a “logging level” field. The “logging level” field includes a “level” field and a “content” field. In log level information 93A, a logging level “low” is associated with the assurance level “high”, a logging level “middle” is associated with the assurance level “middle”, and a logging level “high” is associated with the assurance level “low”. The logging level “low” specifies an API call log as the content of the log. The logging level “middle” specifies an API call log that includes a parameter passed to the API. The logging level “high” specifies a log that includes an API call log and a log of an internal operation in the MFP.

Returning to FIG. 7, when application executing portion 53 has executed an application program, application executing portion 53 outputs application identification information for identifying the executed application program to assurance level detecting portion 55A, logging portion 61A, and forced logging portion 63A, and outputs the result of executing the application program to logging portion 61A and forced logging portion 63A. The result of executing the application program includes either “normal termination” or “abnormal termination”. The execution result may indicate either “normal termination” or “abnormal termination” for each command included in the application program, or for each process in MFP 100. Further, in the case of “abnormal termination”, the result may include an error code which is predetermined for the error that has led to the abnormal termination.

Assurance level detecting portion 55A detects an assurance level at which the execution of an application program is assured externally. In the case where authentication information is associated with an application program stored in HDD 114, assurance level detecting portion 55A detects an assurance level included in the authentication information. When no authentication information is associated with an application program stored in HDD 114, assurance level detecting portion 55A detects no assurance level.

In the case where application identification information is received from installation portion 51, assurance level detecting portion 55A detects an assurance level of application program 91 that is specified by the application identification information among application programs 91 stored in HDD 114. When assurance level detecting portion 55A detects no assurance level of application program 91 that is specified by the application identification information received from installation portion 51, then assurance level detecting portion 55A outputs a notification instruction to notification portion 57.

In the case where application identification information is received from application executing portion 53, assurance level detecting portion 55A detects an assurance level of application program 91 that is specified by the application identification information among application programs 91 stored in HDD 114. When an assurance level is detected, assurance level detecting portion 55A outputs the detected assurance level to logging level determining portion 73. When no assurance level is detected, assurance level detecting portion 55A outputs a logging instruction to forced logging portion 63A.

Logging level determining portion 73 receives an assurance level from assurance level detecting portion 55A, and determines a logging level corresponding to the received assurance level. Logging level determining portion 73 refers to log level information 93A stored in HDD 114 to acquire a logging level corresponding to the assurance level received from assurance level detecting portion 55A, and outputs the acquired logging level to logging portion 61A.

Logging portion 61A keeps a log of an application program, the information content of which is determined by the logging level of the application program. Logging portion 61A receives application identification information and an execution result from application executing portion 53, and receives a logging level from logging level determining portion 73. On receipt of the application identification information and the execution result from application executing portion 53, logging portion 61A stores into HDD 114 a log which includes the information content that is specified by the logging level received from logging level determining portion 73. As a result, log information 95 is stored in HDD 114. Log information 95 includes a set of the application identification information and the execution result. When the logging level is “high”, a log including an API call log and a log of an internal operation in the MFP is stored. When the logging level is “middle”, an API call log that includes a parameter passed to the API is stored. When the logging level is “low”, an API call log is stored.

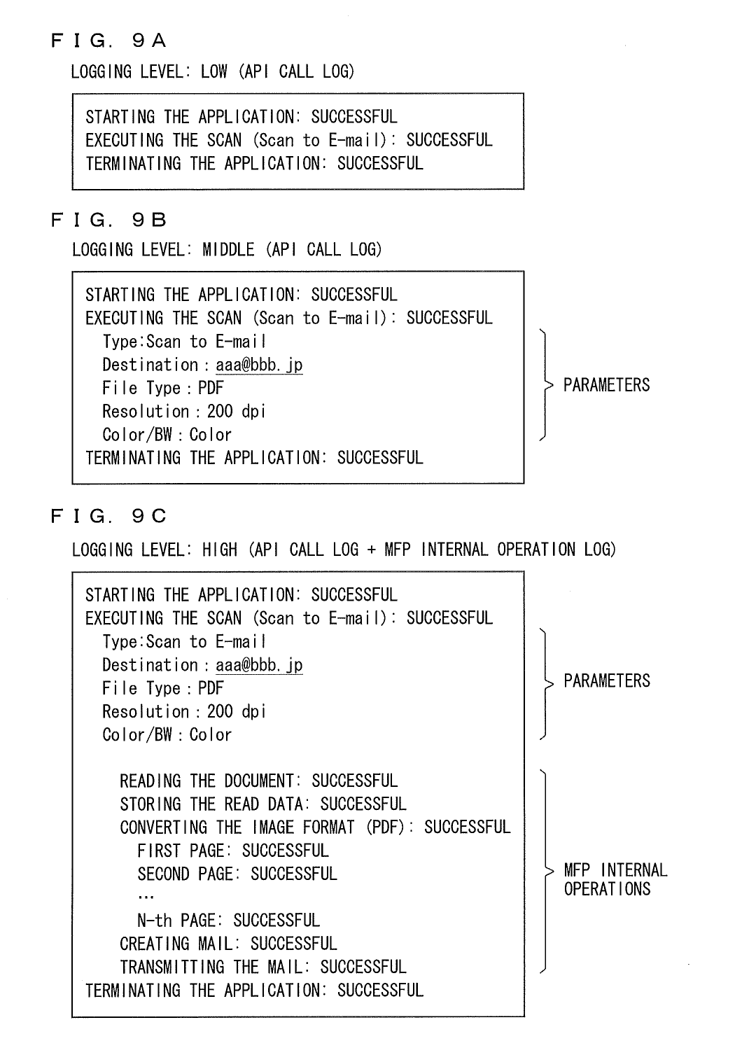

FIGS. 9A to 9C show examples of a log. FIG. 9A shows an example of the log that is kept when the logging level is “low”. Referring to FIG. 9A, the log includes “successful” as an execution result for an API “scan (Scan to E-mail)”.

FIG. 9B shows an example of the log that is kept when the logging level is “middle”. Referring to FIG. 9B, the log includes “successful” as an execution result for the API “scan (Scan to E-mail)”, and the parameters which have been passed to the API.

FIG. 9C shows an example of the log that is kept when the logging level is “high”. Referring to FIG. 9C, the log includes “successful” as an execution result for the API “scan (Scan to E-mail)”, the parameters which have been passed to the API, and the execution results of the internal operations in MFP 100.

Returning to FIG. 7, forced logging portion 63A receives application identification information and an execution result from application executing portion 53, and receives a logging instruction from assurance level detecting portion 55A. On receipt of the logging instruction from assurance level detecting portion 55A, forced logging portion 63A refers to the log level information stored in HDD 114, to acquire a highest logging level. Then, forced logging portion 63A stores into HDD 114 a log including information content that is specified by the acquired highest logging level, provided that the logging level is not changed by a changing portion 75, which will be described later.

Assurance level detecting portion 55A outputs a logging instruction when no authentication information is associated with the application program that has been executed by application executing portion 53, i.e. when the execution of the application program is not assured externally. In the case where an application program the execution of which is not assured externally is executed, forced logging portion 63A stores the log with the information content specified by the highest logging level. The information content that is specified by the highest logging level is the same as the above-described information content of the log that is kept by logging portion 61A when the logging level is “high”. In the case of keeping a log, forced logging portion 63A outputs the application identification information received from application executing portion 53, to log transmitting portion 65.

Forced logging portion 63A includes changing portion 75. Changing portion 75 extracts, from log information 95 stored in HDD 114, any execution result that makes a pair with the application identification information input from application executing portion 53. Then, if the number of execution results showing normal termination included in the extracted execution results meets a predetermined condition, changing portion 75 changes the logging level, at which forced logging portion 63A keeps a log, from the highest logging level to the middle or low logging level corresponding to less information content than in the case of the highest logging level. Whether to change the logging level to the middle logging level or to the low logging level may be determined in accordance with the number of execution results showing normal termination. The predetermined condition may be for example as follows: to change the logging level to the middle or low logging level if the number of execution results showing normal termination is not less than a threshold value TL1 and less than a threshold value TL2, and to change the logging level to the low logging level if the number of execution results showing normal termination is not less than the threshold value TL2. It is noted that the predetermined condition may be determined on the basis of the ratio of the number of execution results showing normal termination to the number of extracted execution results.

If the number of execution results showing normal termination is a prescribed value of more, it is highly likely that a later execution of the application program will end normally. Accordingly, it is configured to reduce the information content of the log for such an application program. This allows a log of least possible information content to be kept, thereby reducing the load on CPU 111.

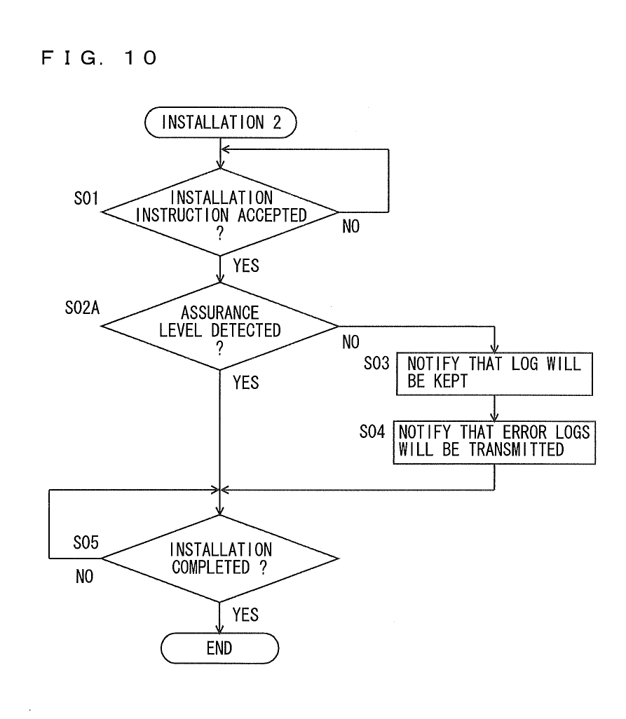

FIG. 10 is a flowchart illustrating an example of the flow of the installation process according to the second embodiment. Referring to FIG. 10, it is different from the installation process shown in FIG. 5 in that step S02 has been changed to step S02A. The other processes are similar to those shown in FIG. 5, and thus, the description thereof will not be repeated here. In step S02A, CPU 111 determines whether an assurance level of the application program that is specified by the installation instruction accepted in step S01 has been detected. If authentication information is associated with the application program stored in HDD 114, an assurance level is detected. If no authentication information is associated with the application program, no assurance level is detected. If an assurance level of the application program has been detected, the process proceeds to step S05; otherwise, the process proceeds to step S03.

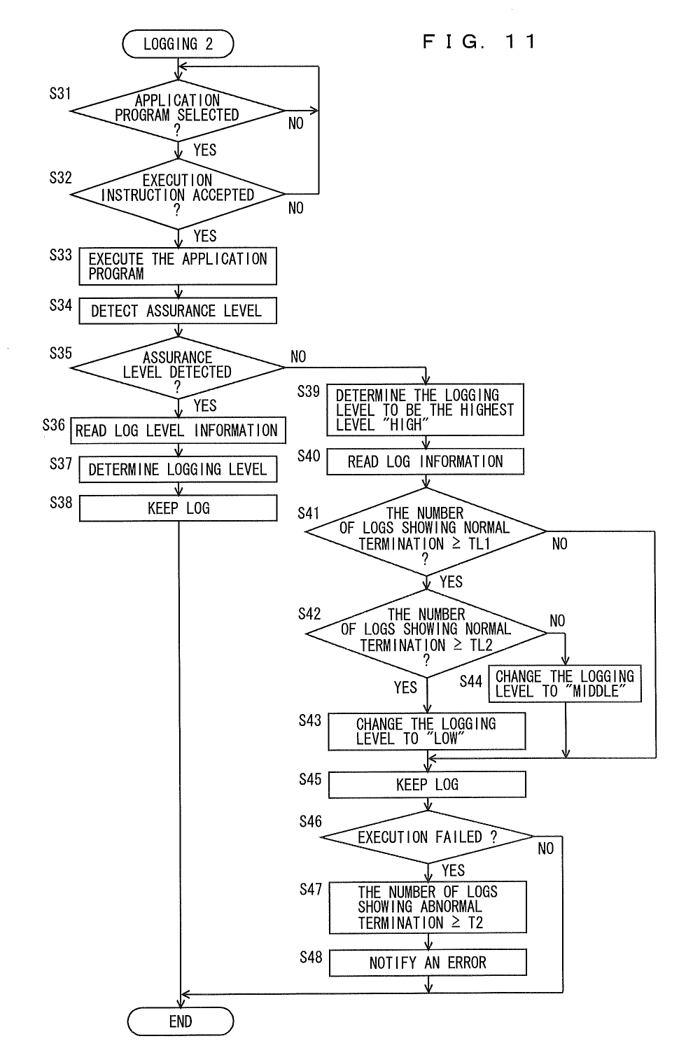

FIG. 11 is a flowchart illustrating an example of the flow of the logging process according to the second embodiment. The logging process is carried out by CPU 111 included in MFP 100 as CPU 111 executes the logging program stored in ROM 112, HDD 114, or CD-ROM 119.

Referring to FIG. 11, steps S31 to S33 are identical to steps S11 to S13, respectively, shown in FIG. 6, and thus, the description thereof will not be repeated here. In step S34, an assurance level is detected. CPU 111 acquires an assurance level included in the authentication information that is associated with the application program selected in step S31.

If the assurance level is detected, the process proceeds to step S36; otherwise, the process proceeds to step S39 (step S35). In the following step S36, CPU 111 reads log level information 93A stored in HDD 114. Then, CPU 111 determines a logging level (step S37), and the process proceeds to step S38. Specifically, from log level information 93A read in step S36, the logging level that is associated with the assurance level detected in step S35 is acquired, and the acquired logging level is set to be the logging level according to which a log is to be kept.

In step S38, CPU 111 keeps a log of the application program executed in step S33, with the information content that is specified by the logging level determined in step S37. Specifically, from the result of executing the application program, a part that is specified by the logging level is extracted, and a set of that part and the application identification information of that application program is additionally stored in log information 95 in HDD 114.

On the other hand, in step S39, the logging level is determined to be the highest logging level within log level information 93A stored in HDD 114, and the process proceeds to step S40. Here, the logging level “high” is set to be the logging level according to which a log is to be kept.

In step S40, log information of the application program selected in step S31 is read. Specifically, from log information 95 stored in HDD 114, any piece of log information 95 that includes the application identification information of the application program selected in step S31 is read.

In the following step S41, it is determined whether the number of logs showing normal termination, in the log information read in step S40, is a threshold value TL1 or more. If so, the process proceeds to step S42; otherwise, the process proceeds to step S45. In step S42, it is determined whether the number of logs showing normal termination, among the pieces of log information read in step S40, is a threshold value TL2 or more. If so, the process proceeds to step S43; otherwise, the process proceeds to step S44. Threshold value TL2 is larger than threshold value TL1.

In step S43, the logging level used for logging is changed from the logging level “high” to the logging level “low”, and the process proceeds to step S45. In step S44, the logging level used for logging is changed from the logging level “high” to the logging level “middle”, and the process proceeds to step S45.

In step S45, a log of the application program executed in step S33 is kept. Specifically, from the result of executing the application program, a part that is specified by the logging level used for logging is extracted, and a set of that part and the application identification information of the application program is additionally stored in log information 95 in HDD 114. The logging level for use in logging is “high” in the case where the number of logs showing normal termination, included in the log information read in step S40, is less than the threshold value TL1. The logging level for use in logging is “middle” in the case where the number of logs showing normal termination is not less than the threshold value TL1 and less than the threshold value TL2. The logging level for use in logging is “low” in the case where the number of logs showing normal termination is not less than the threshold value TL2.

Steps S46 to S48 are identical to steps S21 to S23, respectively, shown in FIG. 6, and thus, the description thereof will not be repeated here.

According to the second embodiment, MFP 100 detects an assurance level (qualified assurance level) at which an application program is assured externally, and detects which one of a plurality of predetermined assurance levels the qualified assurance level corresponds to. In the case where an assurance level that coincides with the qualified assurance level is detected, MFP 100 refers to log level information 93A to determine a logging level corresponding to the detected assurance level, and keeps a log of the application program executed, with the information content that is specified by the determined logging level. In the case where no qualified assurance level is detected, MFP 100 refers to log level information 93A, and keeps the log with the information content that is specified by the highest logging level according to which the largest amount of information content is to be kept in the log. In other words, in the case where an application program the execution of which is not assured externally is executed, a log having the information content that is specified by the highest logging level is kept, while in the case where an application program the execution of which is assured externally is executed, a log having the information content that is specified by the logging level corresponding to the assurance level detected by using the qualified assurance level is kept. An application program the execution of which is not assured externally has a higher probability of occurrence of an error than an application program the execution of which is assured externally. Therefore, in the case where an application program having a high probability of occurrence of an error is executed, a log is kept with the information content that is specified by the highest logging level, thereby allowing the log to be kept with suitable information content. As a result, the information content to be kept in a log can be set as appropriate in accordance with the application program being executed.

Further, in the case where logs that have been kept for an application program for which no assurance level is detected include a prescribed number or more of the logs showing normality, the logging level for use in logging is changed, on the basis of the number of the logs showing normality, from the highest logging level to another one of a plurality of logging levels at which the information content to be kept in a log is less than that to be kept at the highest logging level. After the logging level is changed from the highest logging level to the lower logging level, a log is kept with the information content that is specified by the lower logging level. This can reduce the information content to be kept in a log and, hence, reduce the load on CPU 111.

### Third Embodiment

In application sharing system 1 according to the first embodiment, setting information 93 is stored in HDD 114 in MFP 100, and it is configured such that a log is kept in accordance with setting information 93 in the case where the execution of the application program is assured externally, and that a log is forcibly kept in the case where the execution of the application program is not assured externally. In an application sharing system 1B according to the third embodiment, no setting information 93 is stored in HDD 114 in MFP 100, and it is configured such that a log is kept only in the case where the execution of the application program is not assured externally.

The overall configuration of application sharing system 1B according to the third embodiment is identical to that shown in FIG. 1. The appearance and hardware configuration of MFP 100 are identical to those shown in FIGS. 2 and 3, respectively. Thus, the description thereof will not be repeated here.

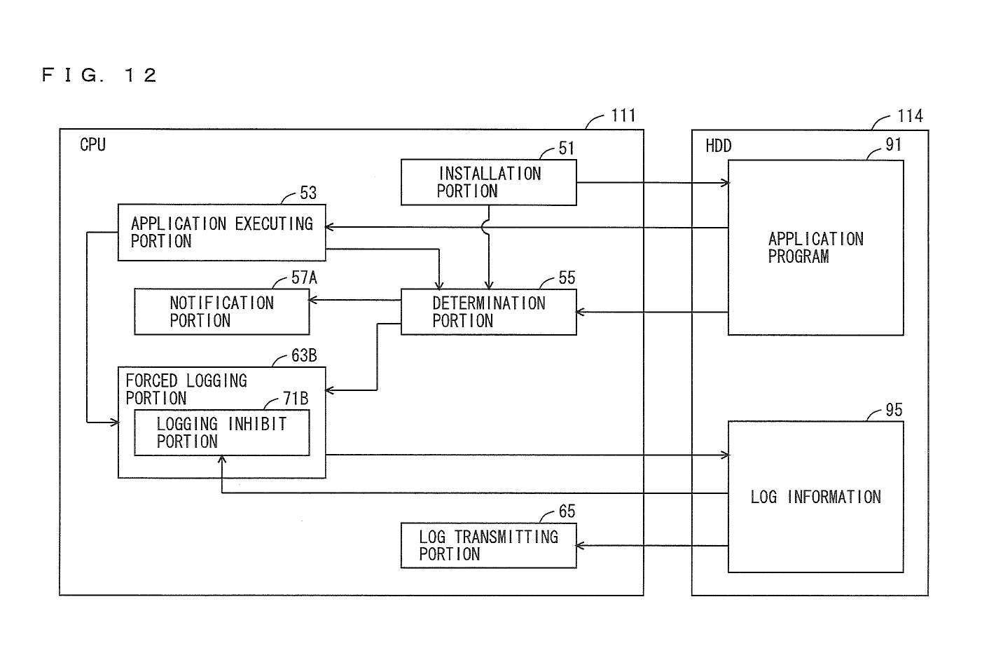

FIG. 12 is a block diagram schematically showing the functions of the CPU included in the MFP according to the third embodiment, together with data stored in a HDD. The functions shown in FIG. 12 are implemented in CPU 111 included in MFP 100 as CPU 111 executes a logging program stored in ROM 112, HDD 114, or CD-ROM 119.

Referring to FIG. 12, it is different from the block diagram shown in FIG. 4 in that setting portion 59 and logging portion 61 have been deleted, and that notification portion 57 has been changed to a notification portion 57A. In the following, differences from the functions shown in FIG. 4 will primarily be described.

When notification portion 57A receives a notification instruction from determination portion 55, notification portion 57A notifies a user that the log is to be forcibly kept, and also notifies that the logs are to be transmitted to the outside. Specifically, notification portion 57A displays, on display portion 115, a message to the effect that the log is to be forcibly kept and a message to the effect that the logs are to be transmitted to the outside.

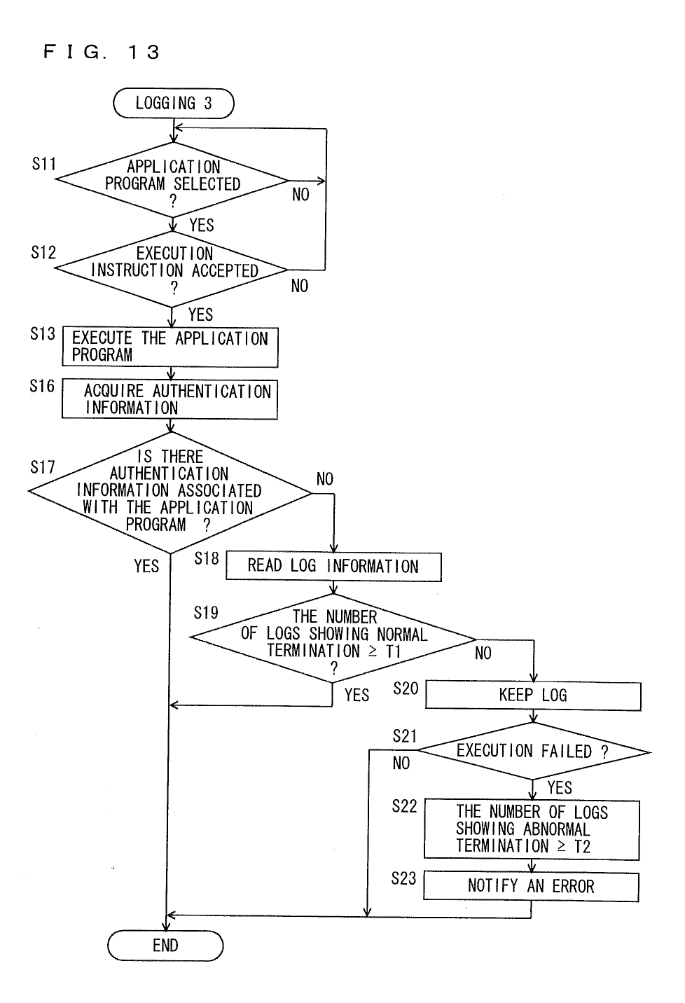

FIG. 13 is a flowchart illustrating an example of the flow of the logging process according to the third embodiment. The logging process is carried out by CPU 111 included in MFP 100 as CPU 111 executes the logging program stored in ROM 112, HDD 114, or CD-ROM 119.

Referring to FIG. 13, it is different from the logging process shown in FIG. 6 in that steps S14 and S15 have been deleted. The other processes are similar to those shown in FIG. 6, and thus, the description thereof will not be repeated here. With steps S14 and S15 not being performed, a log is kept in step S20 only in the case where authentication information is not acquired in step S16 (NO in step S17).

According to the third embodiment, MFP 100 determines whether the execution of an application program is assured externally. When determining that the execution of the application program is assured externally, MFP 100 keeps no log of the application program executed. When determining that the execution of the application program is not assured externally, MFP 100 keeps a log of the application program executed. This allows only a log of an application program having a high probability of occurrence of an error to be stored.

In the case where the logs that have been kept for an application program the execution of which is not assured externally include a prescribed number or more of logs showing normality, MFP 100 keeps no log. This can reduce the number of processes of keeping logs, thereby allowing a reduction in load on CPU 111.

While MFP 100 has been described in the above embodiment as an example of the information processing apparatus, the present invention may of course be understood as a logging method or a logging program for causing a computer to execute the processes shown in FIGS. 5, 6, 10, 11, and 13.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information processing apparatus comprising:
an application executing portion configured to execute an application program;
a setting portion configured to set whether to keep a log of said application program executed by said application executing portion; and
a logging portion configured to, in the case where it has been set to keep the log by said setting portion, keep a log of said application program executed,
said logging portion including
a determination portion configured to determine whether the execution of said application program is assured externally, and
a forced logging portion configured to keep a log of said application program executed, in the case where it is determined that the execution of said application program is not assured externally, even if it has been set not to keep the log by said setting portion.

2. The information processing apparatus according to claim 1, wherein said forced logging portion includes a logging inhibit portion configured to inhibit a log from being kept by said forced logging portion in the case where the number of logs showing normality, included in logs which have been kept by said logging portion for said application program the execution of which is not assured externally, satisfies a prescribed condition.

3. The information processing apparatus according to claim 1, further comprising a logging notification portion configured to, in the case where it is determined at the time of installation of an application program that the execution of the application program being installed is not assured externally and in the case where it has been set not to keep the log by said setting portion, notify that the log is to be forcibly kept.

4. The information processing apparatus according to claim 1, further comprising:
an error transmitting portion configured to, in the case where the logs that have been kept by said forced logging portion for said application program the execution of which is not assured externally include a prescribed number or more of the logs showing abnormality, transmit said logs to the outside; and
a log-transmitting notification portion configured to, in the case where it is determined at the time of installation of an application program that the execution of the application program being installed is not assured externally and in the case where it has been set not to keep the log by said setting portion, notify that the logs are to be transmitted to the outside by said error transmitting portion.

5. An information processing apparatus comprising:
an application executing portion configured to execute an application program;
an assurance level detecting portion configured to detect a qualified assurance level at which said application program is assured externally, and detect which one of a plurality of predetermined assurance levels the qualified assurance level corresponds to;
a logging level determining portion configured to, in the case where the qualified assurance level has been detected by said assurance level detecting portion, determine a logging level corresponding to said detected assurance level by referring to a log level table in which said plurality of assurance levels are associated with a plurality of logging levels, respectively, such that the higher the assurance level, the lower the logging level;
a logging portion configured to keep a log of said application program executed, with information content that is specified by said determined logging level; and
a forced logging portion configured to, in the case where no qualified assurance level has been detected by said assurance level detecting portion, keep a log of said application program executed, with information content that is specified by a highest logging level among said plurality of logging levels at which a largest amount of information content is kept in the log.

6. The information processing apparatus according to claim 5, wherein
said forced logging portion includes a changing portion configured to, in the case where the number of logs showing normality, included in logs that have been kept for said application program for which no qualified assurance level has been detected by said assurance level detecting portion, satisfies a prescribed condition, change the logging level, on the basis of the number of the logs showing normality, from said highest logging level to another one of said plurality of logging levels at which the information content to be kept is less than that to be kept at said highest logging level, and
in the case where the logging level is changed from said highest logging level to said lower logging level by said changing portion, said forced logging portion keeps the log with the information content that is specified by said lower logging level.

7. An information processing apparatus comprising:
an application executing portion configured to execute an application program;
a determination portion configured to determine whether the execution of said application program is assured externally; and
a logging portion configured to, in the case where it is determined that the execution of said application program is assured externally, keep no log of said application program executed, and configured to, in the case where it is determined that the execution of said application program is not assured externally, keep a log of said application program executed.

8. The information processing apparatus according to claim 7, wherein said logging portion includes a logging inhibit portion configured to inhibit a log from being kept on the basis of the number of logs showing normality included in said logs kept for said application program the execution of which is not assured externally.

9. A logging method comprising:
a step of executing an application program;
a step of setting whether to keep a log of said application program executed; and
a logging step of, in the case where it has been set to keep the log, keeping a log of said application program executed,
said logging step including
a determining step of determining whether the execution of said application program is assured externally, and
a forced logging step of keeping a log of said application program executed, in the case where it is determined that the execution of said application program is not assured externally, even if it has been set not to keep the log in said setting step.

10. The logging method according to claim 9, wherein said forced logging step includes a logging inhibit step of inhibiting a log from being kept in said forced logging step in the case where the number of logs showing normality, included in logs which have been kept in said logging step for said application program the execution of which is not assured externally, satisfies a prescribed condition.

11. The logging method according to claim 9, further comprising a step of, in the case where it is determined at the time of installation of an application program that the execution of the application program being installed is not assured externally and in the case where it has been set not to keep the log in said setting step, notifying that the log is to be forcibly kept.

12. The logging method according to claim 9, further comprising:
an error transmitting step of, in the case where the logs that have been kept in said forced logging step for said application program the execution of which is not assured externally include a prescribed number or more of the logs showing abnormality, transmitting said logs to the outside; and
a step of, in the case where it is determined at the time of installation of an application program that the execution of the application program being installed is not assured externally and in the case where it has been set not to keep the log in said setting step, notifying that the logs are to be transmitted to the outside in said error transmitting step.

13. A logging method comprising:
a step of executing an application program;
a step of detecting a qualified assurance level at which said application program is assured externally, and detecting which one of a plurality of predetermined assurance levels the qualified assurance level corresponds to;
a step of, in the case where the qualified assurance level has been detected in said detecting step, determining a logging level corresponding to said detected assurance level by referring to a log level table in which said plurality of assurance levels are associated with a plurality of logging levels, respectively, such that the higher the assurance level, the lower the logging level;
a logging step of keeping a log of said application program executed, with information content that is specified by said determined logging level; and
a forced logging step of, in the case where no qualified assurance level has been detected in said detecting step, keeping a log of said application program executed, with information content that is specified by a highest logging level among said plurality of logging levels at which a largest amount of information content is kept in the log.

14. The logging method according to claim 13, wherein said forced logging step includes steps of
in the case where the number of logs showing normality, included in logs that have been kept for said application program for which no qualified assurance level has been detected in said detecting step, satisfies a prescribed condition, changing the logging level, on the basis of the number of the logs showing normality, from said highest logging level to another one of said plurality of logging levels at which the information content to be kept is less than that to be kept at said highest logging level, and
in the case where the logging level is changed from said highest logging level to said lower logging level in said changing step, keeping the log with the information content that is specified by said lower logging level.

15. A logging method comprising:
a step of executing an application program;
a step of determining whether the execution of said application program is assured externally; and
a logging step of, in the case where it is determined that the execution of said application program is assured externally, keeping no log of said application program executed, and, in the case where it is determined that the execution of said application program is not assured externally, keeping a log of said application program executed.

16. The logging method according to claim 15, wherein said logging step includes a step of inhibiting a log from being kept on the basis of the number of logs showing normality included in said logs kept for said application program the execution of which is not assured externally.

17. A non-transitory computer-readable recording medium encoded with a logging program, said logging program causing a computer to execute:
a step of executing an application program;
a step of setting whether to keep a log of said application program executed; and
a logging step of, in the case where it has been set to keep the log, keeping a log of said application program executed,
said logging step including
a determining step of determining whether the execution of said application program is assured externally, and
a forced logging step of keeping a log of said application program executed, in the case where it is determined that the execution of said application program is not assured externally, even if it has been set not to keep the log in said setting step.

18. The non-transitory computer-readable recording medium encoded with the logging program according to claim 17, wherein said forced logging step includes a logging inhibit step of inhibiting a log from being kept in said forced logging step in the case where the number of logs showing normality, included in logs which have been kept in said logging step for said application program the execution of which is not assured externally, satisfies a prescribed condition.

19. The non-transitory computer-readable recording medium encoded with the logging program according to claim 17, said logging program causing said computer to further execute a step of, in the case where it is determined at the time of installation of an application program that the execution of the application program being installed is not assured externally and in the case where it has been set not to keep the log in said setting step, notifying that the log is to be forcibly kept.

20. The non-transitory computer-readable recording medium encoded with the logging program according to claim 17, said logging program causing said computer to further execute:
an error transmitting step of, in the case where the logs that have been kept in said forced logging step for said application program the execution of which is not assured externally include a prescribed number or more of the logs showing abnormality, transmitting said logs to the outside; and
a step of, in the case where it is determined at the time of installation of an application program that the execution of the application program being installed is not assured externally and in the case where it has been set not to keep the log in said setting step, notifying that the logs are to be transmitted to the outside in said error transmitting step.

21. A non-transitory computer-readable recording medium encoded with a logging program, said logging program causing a computer to execute:
a step of executing an application program;
a step of detecting a qualified assurance level at which said application program is assured externally, and detecting which one of a plurality of predetermined assurance levels the qualified assurance level corresponds to;
a step of, in the case where the qualified assurance level has been detected in said detecting step, determining a logging level corresponding to said detected assurance level by referring to a log level table in which said plurality of assurance levels are associated with a plurality of logging levels, respectively, such that the higher the assurance level, the lower the logging level;
a logging step of keeping a log of said application program executed, with information content that is specified by said determined logging level; and
a forced logging step of, in the case where no qualified assurance level has been detected in said detecting step, keeping a log of said application program executed, with information content that is specified by a highest logging level among said plurality of logging levels at which a largest amount of information content is kept in the log.

22. The non-transitory computer-readable recording medium encoded with the logging program according to claim 21, wherein said forced logging step includes steps of:
in the case where the number of logs showing normality, included in logs that have been kept for said application program for which no qualified assurance level has been detected in said detecting step, satisfies a prescribed condition, changing the logging level, on the basis of the number of the logs showing normality, from said highest logging level to another one of said plurality of logging levels at which the information content to be kept is less than that to be kept at said highest logging level, and
in the case where the logging level is changed from said highest logging level to said lower logging level in said changing step, keeping the log with the information content that is specified by said lower logging level.

23. A non-transitory computer-readable recording medium encoded with a logging program, said logging program causing a computer to execute:
a step of executing an application program;
a step of determining whether the execution of said application program is assured externally; and
a logging step of, in the case where it is determined that the execution of said application program is assured externally, keeping no log of said application program executed, and, in the case where it is determined that the execution of said application program is not assured externally, keeping a log of said application program executed.

24. The non-transitory computer-readable recording medium encoded with the logging program according to claim 23, wherein said logging step includes a step of inhibiting a log from being kept on the basis of the number of logs showing normality included in said logs kept for said application program the execution of which is not assured externally.
